(19) United States
(12) Patent Application Publication
(10) Pub. No.: US 2010/0036837 A1
(43) Pub. Date: Feb. 11, 2010

(54) INFORMATION SEARCH METHOD AND INFORMATION SEARCH APPARATUS

(75) Inventors: Takahiso ANDO, Kawasaki (JP); Satoko SHIGA, Kawasaki (JP); Akira SATO, Kawasaki (JP); Taisuya ASAI, Kawasaki (JP); Seishi OKAMOTO, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/537,232

(22) Filed: Aug. 6, 2009

(30) Foreign Application Priority Data
Aug. 7, 2008 (JP) 2008-204265

(51) Int. Cl. G06F 17/30; G06F 21/00; G06F 15/16

(52) U.S. Cl. 707/5; 726/4; 707/3; 709/206; 709/206; 707/E17.014; 707/E17.032

(57) ABSTRACT

An information search apparatus includes a receiving unit which receives a search request from a searcher's terminal; a search unit which searches and retrieves, from a database, candidate information that includes a content satisfying a search criteria set in the search request; a constriction unit which constricts the retrieved candidate information based on similarities between an attribute of an authorized person who is authorized to determine disclosure or non-disclosure of the candidate information included in the candidate information, and an attribute of the searcher who transmits the search request from the searcher's terminal; and a transmission unit which transmits disclosure requests for the constricted candidate information to an authorized person's terminal and transmits candidate information in which a response for the disclosure request received by the receiving unit is set to permit disclosure to the searcher's terminal.

### CROSS-REFERENCE TO RELATED APPLICATIONS

This application is based upon and claims the benefit of priority of the prior Japanese Patent Application No. 2008-204265, filed on Aug. 7, 2008, the entire contents of which are incorporated herein by reference.

### FIELD

Certain aspects of the present invention discussed herein are related to an information search method and an information search apparatus.

### BACKGROUND

Various techniques for sharing and exchanging information via a network have been proposed. For example, a mailing list system allows users to share information using e-mails among users who are registered to a mail server as one group.

In order to further promote sharing information, a technique is proposed that provides a shared database in which information on e-mails are registered. The technique allows a third party to refer to information about e-mails that are set to permit disclosure among e-mails registered in the database.

### SUMMARY

According to an aspect of the embodiments, an information search apparatus includes a receiving unit which receives a search request from a searcher's terminal; a search unit which searches and retrieves, from a database, candidate information that includes a content satisfying a search criteria set in the search request; a constriction unit which constricts the retrieved candidate information based on similarities between an attribute of an authorized person who is authorized to determine disclosure or non-disclosure of the candidate information included in the candidate information and an attribute of the searcher who transmits the search request from the searcher's terminal; and a transmission unit which transmits disclosure requests for the constricted candidate information to an authorized person's terminal and transmits candidate information in which a response for the disclosure request received by the receiving unit is set to permit disclosure to the searcher's terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of an internal network to which an e-mail disclosure apparatus is coupled and a configuration of an external network to which the internal network is coupled;

FIG. 2 illustrates a hardware configuration of an e-mail disclosure apparatus;

FIG. 3 illustrates a software configuration of an e-mail disclosure apparatus;

FIG. 4 is a conceptual figure of a method for constricting (narrowing-down) disclosure candidate e-mails;

FIG. 5 is an example of a disclosure request e-mail displayed on a terminal of a receiver who receives a disclosure candidate e-mail;

FIG. 6 is a screen in which a receiver of a disclosure candidate e-mail sets response information for a disclosure request e-mail;

FIG. 7 illustrates a list of disclosure e-mails displayed on an inquirer's terminal;

FIG. 8 is a figure for describing a method for acquiring relay history information of a sender side and that of a receiver side from header information of a related e-mail;

FIG. 9 illustrates a transmission route of a disclosure candidate e-mail;

FIG. 10A is a figure for describing a method for obtaining a distance between a sender and an inquirer;

FIG. 10B is a figure for describing a method for obtaining a distance between a receiver and an inquirer;

FIG. 11 illustrates a configuration of a management table stored in a RAM;

FIG. 12A and FIG. 12B illustrate methods for selecting disclosure candidate e-mails and sending disclosure request e-mails to receivers of the disclosure candidate e-mails.

FIG. 13 illustrates a configuration of a management table of an e-mail accumulation database;

FIG. 14 is a flow chart illustrating an operational overview of an e-mail disclosure apparatus;

FIG. 15 is a flow chart illustrating procedures for selecting disclosure candidate e-mails from related e-mails;

FIG. 16 is a flow chart illustrating processing procedures for calculating a distance between a sender or a receiver of a disclosure candidate e-mail and an inquirer;

FIG. 17 is a flow chart illustrating procedures for comparing relay history information of an inquiry e-mail and that of a sender side;

FIG. 18 illustrates a configuration of a management table recorded in a RAM according to a second embodiment;

FIG. 19 is a figure for describing a method for sorting disclosure candidate e-mails according to the second embodiment;

FIG. 20A and FIG. 20B illustrate a flow chart of procedures for calculating a distance between a sender and a receiver of a disclosure candidate e-mail and an inquirer according to the second embodiment; and

FIG. 21 is a flow chart illustrating procedures for changing a condition for constricting disclosure candidate e-mails.

### DESCRIPTION OF EMBODIMENTS

A system configuration of a first embodiment will be described with reference to the figures.

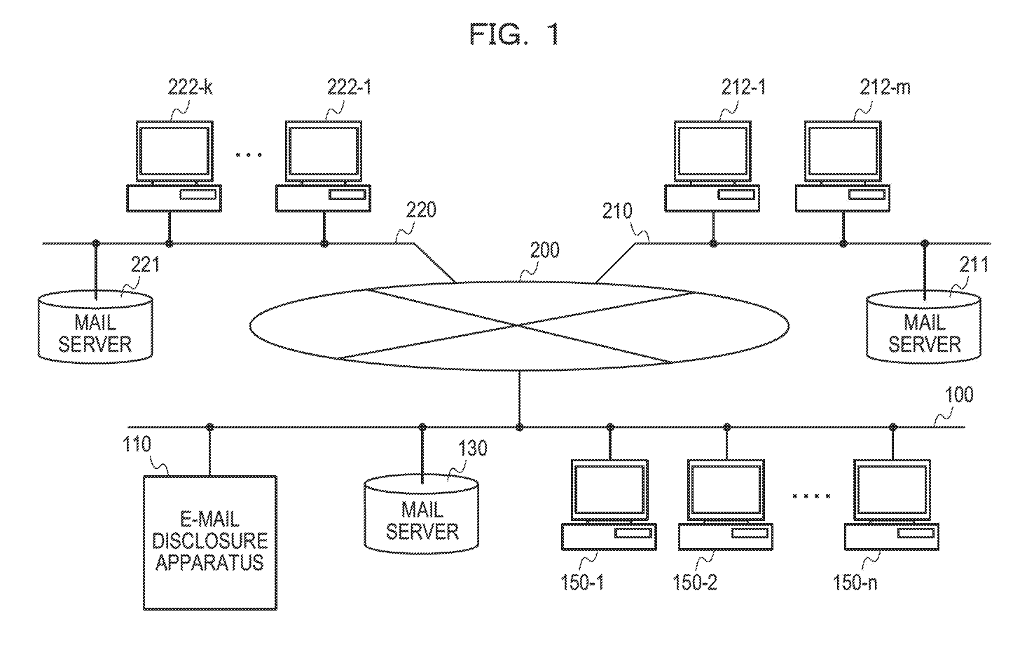

First, a system configuration of the first embodiment will be described by referring to FIG. 1.

In the system of the first embodiment, an e-mail disclosure apparatus 110, a mail server 130, and a plurality of terminals 150-1, 150-2 . . . 150-n (“n” is any natural number) are coupled to an internal network 100. When there is no need to distinguish 150-n, the terminals are generically called “terminal 150.”

An internal network 100 may be, for example, a network that is provided within a company, more specifically, a Local Area Network (LAN) or a Wide Area Network (WAN).

The internal network 100 is coupled to an external network 200 such as the Internet or a public network. Other networks such as a LAN and a WAN may be coupled to the external network 200. In an example illustrated in FIG. 1, a network 210 and a network 220 are coupled to the external network 200. The network 210 is coupled to a mail server 211 and terminals 212-1, 212-2 . . . 212-m (“m” is any natural number). Likewise, the network 220 is coupled to a mail server 221 and terminals 222-1, 222-2 . . . 222-k (“k” is any natural number). When there is no need to distinguish terminals 212-1, 212-2 . . . 212-m, the terminals are generically called “terminal 212.” Likewise, when there is no need to distinguish terminals 222-1, 222-2 . . . 222-k, the terminals are generically called “terminal 222.”

In FIG. 1, devices typically installed on a network including relay apparatuses such as a router or a bridge, a firewall, and a proxy server are not illustrated.

The mail server 130 accumulates e-mails directed to users who use the terminals 150-1, 150-2 . . . 150-n. The users who use the terminals 150-1, 150-2 . . . 150-n access the mail server 130 by using browser software and view the e-mails directed to the users that are accumulated in the mail server 130.

The e-mail disclosure apparatus 110 acquires e-mails accumulated in the mail server 130. When the e-mail disclosure apparatus 110 receives inquiry e-mails from terminals 150, 212, and 222, the e-mail disclosure apparatus 110 retrieves e-mails related to the content of the inquiry from the acquired e-mails. Furthermore, the e-mail disclosure apparatus 110 constricts (narrows down) e-mails that are likely to be disclosed from the found e-mails. According to the embodiment, the e-mail disclosure apparatus 110 constricts e-mails by using an attribute of an inquirer of an inquiry e-mail and an attribute of an authorized person (a sender or a receiver of an e-mail according to this embodiment) who may set an e-mail to allow or not allow disclosure. In other words, the e-mail disclosure apparatus 110 constricts e-mails that are likely to be disclosed based on the proximity of an organization to which the inquirer belongs and an organization to which the authorized person belongs. The e-mail disclosure apparatus 110 inquires of the authorized persons of the constricted e-mails (a receiver of the e-mail according to this embodiment) as to whether or not the constricted e-mails may be disclosed.

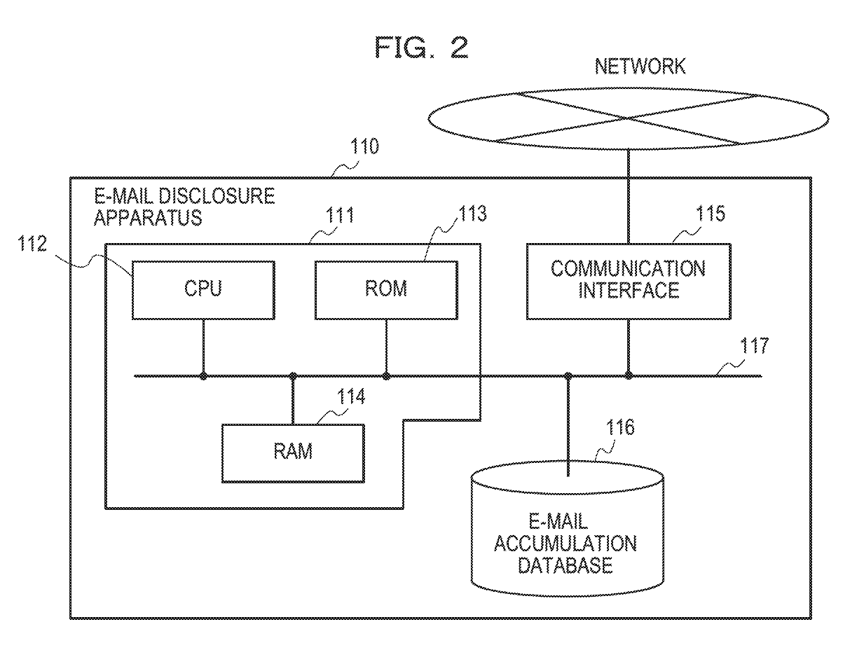

FIG. 2 is a hardware configuration of the e-mail disclosure apparatus 110.

The e-mail disclosure apparatus 110 includes a control unit 111, a communication interface 115, and an e-mail accumulation database 116.

The control unit 111 includes a Central Processing Unit (CPU) 112, a Read Only Memory (ROM) 113, and a Random Access Memory (RAM) 114. Each component in the control unit 111, the communication interface 115, and the e-mail accumulation database 116 are coupled via an internal bus 117.

The communication interface 115 transmits and receives data to and from other devices. The communication interface 115 communicates with the terminals 150 and the mail server 130 that are coupled to the internal network 100. The communication interface 115 also communicates with the terminals 212 and the terminals 222, and the mail server 211 and the mail server 221 that are connected to the external network 200.

The e-mail accumulation database 116 accumulates e-mails acquired from the mail server 130.

The ROM 113 stores a program executed by the CPU 112. The RAM 114 is used as a work memory for the CPU 112, and temporarily stores data being processed by the CPU 112 or result data after processing.

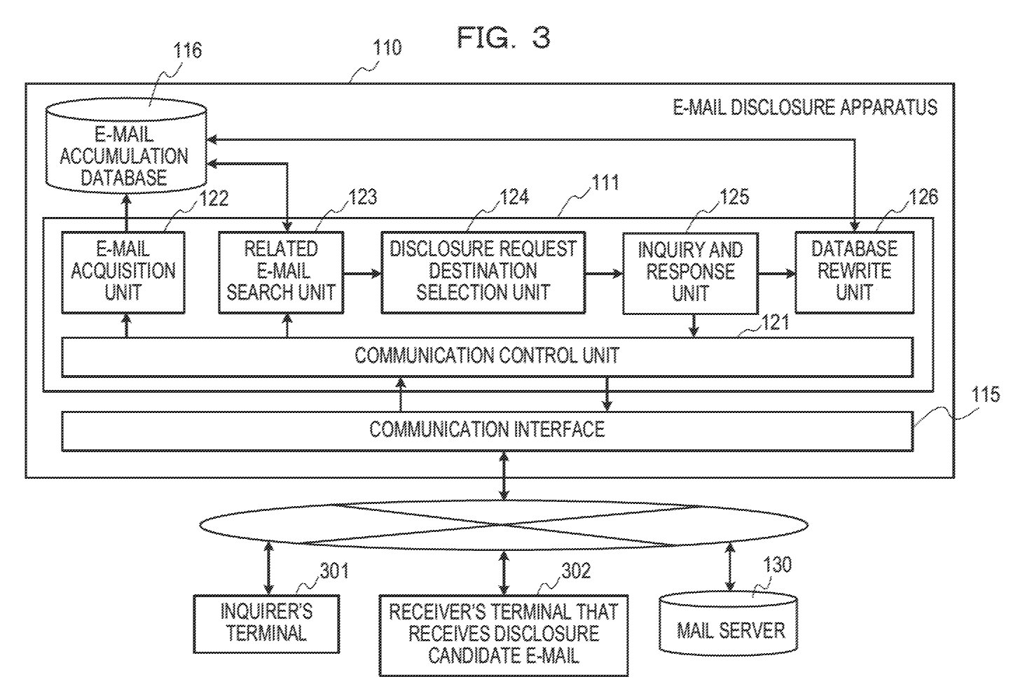

The CPU 112 reads a program stored in the ROM 113 and performs an arithmetic processing according to the read program. FIG. 3 illustrates a configuration of a software processing realized by a program control by the CPU 112.

The software processing is realized by a communication control unit 121, an e-mail acquisition unit 122, a related e-mail search unit (search unit) 123, a disclosure request destination selection unit 124, an inquiry and response unit 125, and a database rewrite unit 126.

The communication control unit 121 communicates with other devices via the communication interface 115. For example, the communication control unit 121 acquires e-mails accumulated in the mail server 130, receives an inquiry e-mail from an inquirer's terminal 301 (a searcher's terminal according to the disclosure), and notifies a disclosure candidate e-mail receiver's terminal 302 of a request to disclose the e-mail. The inquirer's terminal 301 may be a terminal 150 that is coupled to the internal network 100 or one of the terminals 212 and 222 that are coupled to the external network 200. The disclosure candidate e-mail receiver's terminal 302 may be a terminal 150 coupled to the internal network 100. Details of the inquiry e-mail, the disclosure candidate e-mail, and a request to disclose an e-mail will be described later.

The e-mail acquisition unit 122 acquires e-mails accumulated in the mail server 130 and stores the acquired e-mails in the e-mail accumulation database 116.

The related e-mail search unit 123 searches the e-mail accumulation database 116 using a search word described in an inquiry e-mail sent from an inquirer.

A user (hereunder, called an “inquirer”) who uses the e-mail disclosure apparatus 110 transmits an e-mail (hereunder, called an “inquiry e-mail”) in which information that the inquirer wants to search (hereunder, called a “search word”) is described from the inquirer's terminal 301 to the e-mail disclosure apparatus 110. When the communication control unit 121 of the e-mail disclosure apparatus 110 receives the inquiry e-mail via the communication interface 115, the apparatus 110 outputs the inquiry e-mail to the related e-mail search unit 123.

The related e-mail search unit 123 searches the e-mail accumulation database 116 using the search word set in the inquiry e-mail as a keyword. The related e-mail search unit 123 searches the e-mail accumulation database 116 for e-mails that include the search word in attribute information such as a text or a title.

A natural sentence may be used as a search word. The related e-mail search unit 123 separates a natural sentence set in an inquiry e-mail into words and searches the e-mail accumulation database 116 for e-mails that include similar words as the separated words.

The found e-mails are notified to the disclosure request destination selection unit 124 as related e-mails.

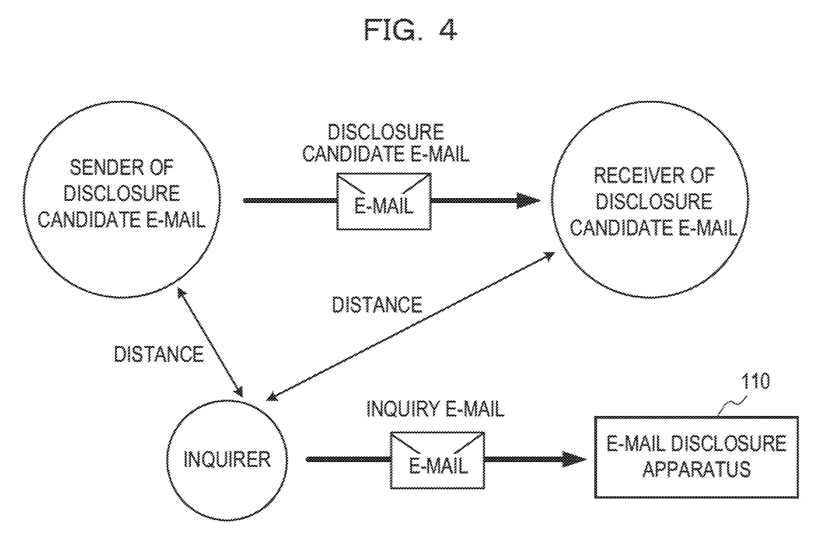

As illustrated in FIG. 4, the disclosure request destination selection unit 124 calculates a distance between a sender (inquirer) of the inquiry e-mail and the sender of the related e-mail found by the related e-mail search unit 123 and a distance between the sender (inquirer) of the inquiry e-mail and the receiver of the related e-mail found by the unit 123. The distance is an indicator of the proximity of the sender to the receiver of the related e-mail within the organization. Hereunder, when both a sender and/or a receiver of a related e-mail are described, they are collectively called a party.

When the calculated distance between the sender of the inquiry e-mail and the party is within a given value, the disclosure request destination selection unit 124 sets the related e-mail as a disclosure candidate e-mail. The inquiry and response unit 125 asks for the disclosure of e-mails set as disclosure candidate e-mails.

The inquiry and response unit 125 generates an e-mail that inquires of a receiver of the disclosure candidate e-mail about whether or not the e-mail may be disclosed. The generated e-mail is output to the communication control unit 121 and transmitted by the communication control unit 121 to the disclosure candidate e-mail receiver's terminal 302.

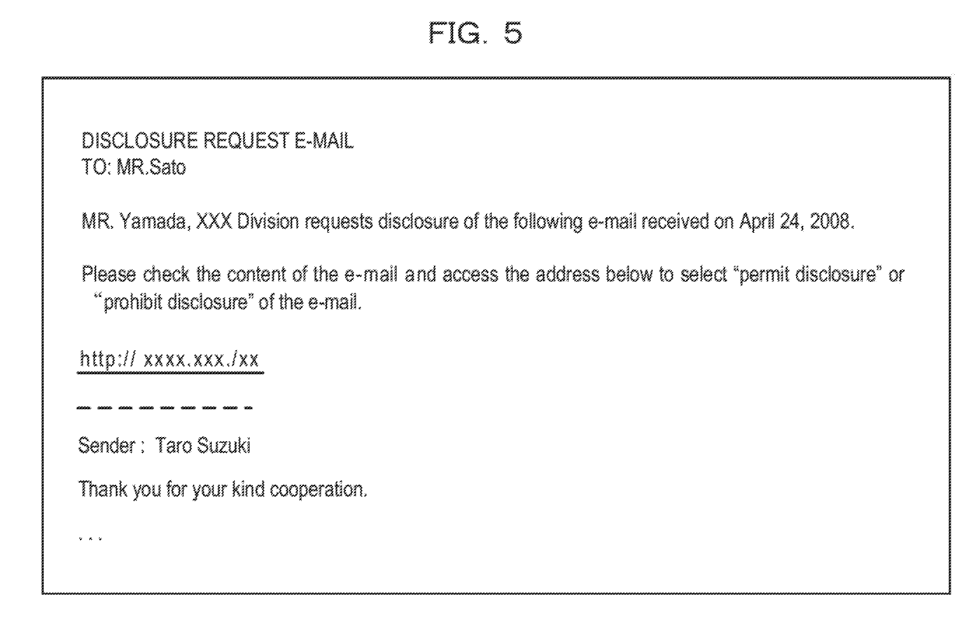

FIG. 5 is a screen example of a disclosure request e-mail that is transmitted to the receiver of the disclosure candidate e-mail by the inquiry and response unit 125. The disclosure request e-mail includes a text that requests disclosure of a disclosure candidate e-mail and the following: the name of the inquirer who requests the disclosure, the division to which the inquirer belongs, the date when the candidate e-mail is received, the sender of the disclosure candidate e-mail, and the content of the candidate e-mail. The disclosure request e-mail indicates a Uniform Resource Locator (URL) to link to a screen for setting disclosure or non-disclosure of the disclosure candidate e-mail.

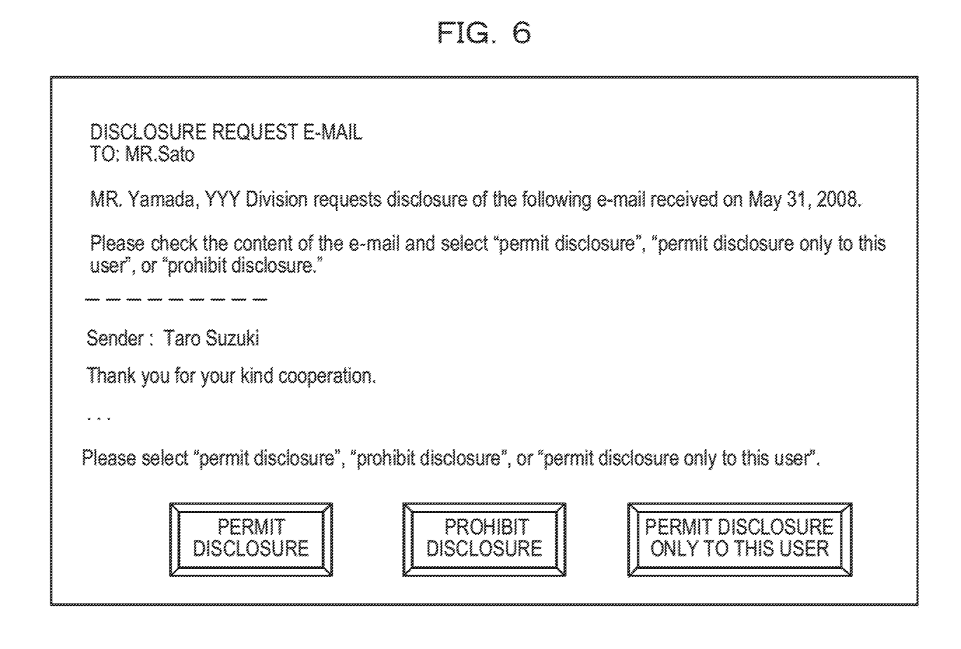

The receiver of the disclosure candidate e-mail who receives the disclosure request e-mail selects the link information in the disclosure request e-mail to display a screen for setting the disclosure or non-disclosure of the e-mail provided by the e-mail disclosure apparatus 110 as illustrated in FIG. 6. The receiver of the disclosure candidate e-mail sets the disclosure or non-disclosure of the candidate e-mail in the screen. There are three patterns that the receiver of the disclosure candidate e-mail may set for the e-mail. The first pattern is to disclose the candidate e-mail not only to the inquirer but also to all users. The second pattern is to prohibit disclosing the candidate e-mail. The third pattern is to allow disclosing the candidate e-mail only to the inquirer.

When the receiver of the disclosure candidate e-mail sets the disclosure or non-disclosure of the candidate e-mail on the screen for setting disclosure or non-disclosure of the e-mail, the set information is transmitted to the e-mail disclosure apparatus 110 as response information.

The communication control unit 121 of the e-mail disclosure apparatus 110 receives the response information that sets the disclosure or non-disclosure of the disclosure candidate e-mail via the communication interface 115. The communication control unit 121 outputs the received response information that sets the disclosure or non-disclosure of the candidate e-mail to the inquiry and response unit 125.

The inquiry and response unit 125 receives the response information that sets the disclosure or non-disclosure of the candidate e-mail and generates a response e-mail for the inquirer.

If all of the response information units for the disclosure requests sent to the receivers of the candidate e-mails are set to non-disclosure, the inquiry and response unit 125 generates a response e-mail that states, for example, “There is no e-mail available that may be disclosed.”

If the response information from the receiver of the disclosure candidate e-mail includes a response that “The disclosure candidate e-mail is permitted to be disclosed only to the inquirer”, the inquiry and response unit 125 transmits the candidate e-mail to the inquirer's terminal 301 as a disclosure e-mail.

If the response information for the disclosure request sent from the receiver of the candidate e-mail includes a response that “the candidate e-mail is permitted to be disclosed to all inquirers”, the inquiry and response unit 125 transmits the candidate e-mail to the inquirer's terminal 301 as a disclosure e-mail. Furthermore, the inquiry and response unit 125 requests rewriting attribute information of the disclosure candidate e-mail to the database rewrite unit 126.

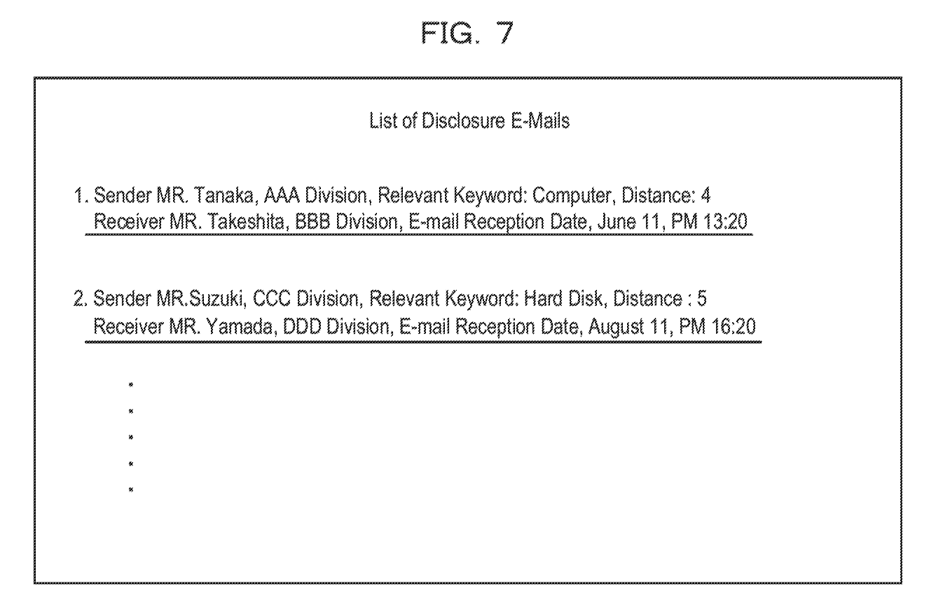

If the number of disclosure e-mails is too many, information on the disclosure e-mails may be transmitted instead of directly sending the disclosure e-mails to the inquirer's terminal 301 so that the inquirer may select e-mails for viewing. FIG. 7 illustrates an example of a response e-mail screen. The response e-mail in FIG. 7 illustrates the names and divisions of a sender and a receiver of the e-mail that is permitted to be disclosed, and the received date and time of the disclosure e-mail, information on a distance between the inquirer and the receiver or the sender of the disclosure e-mail, the relevant search word, and the like.

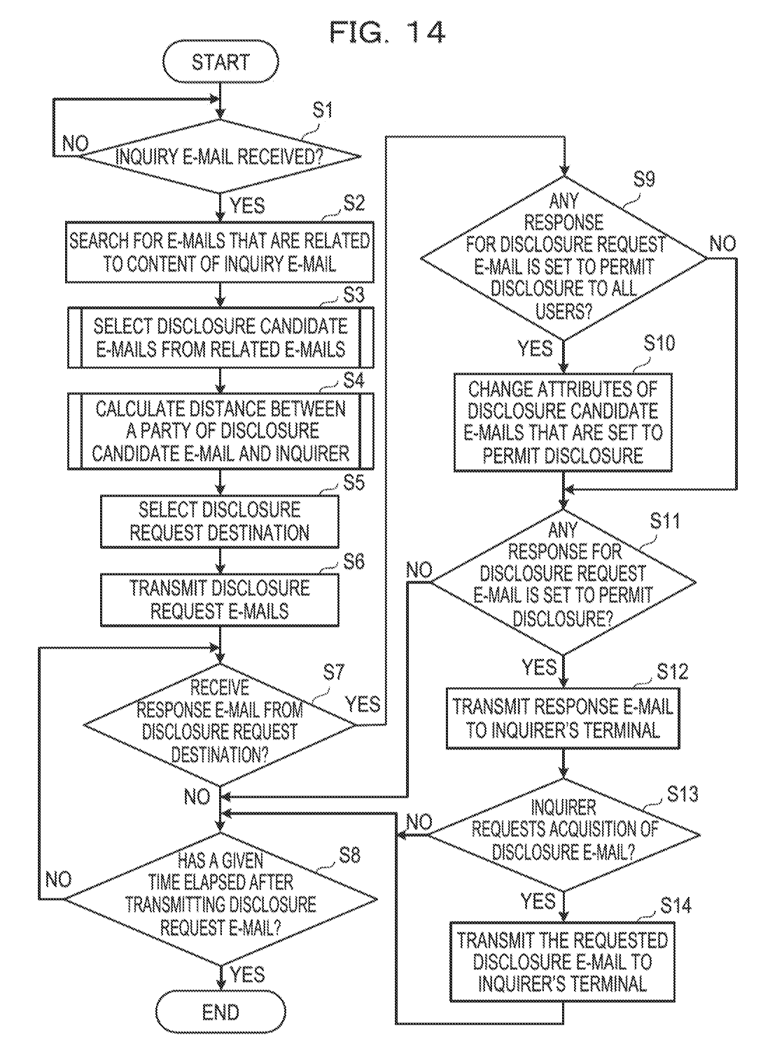

The database rewrite unit 126 rewrites attributes information of the disclosure candidate e-mail notified by the inquiry and response unit 125. In other words, the database rewrite unit 126 rewrites a disclosure attribute of the disclosure candidate e-mail that is permitted to be disclosed to all users to “1” indicating disclosure is permitted (Refer to FIG. 13).

Now, methods to select disclosure candidate e-mails from related e-mails will be described.

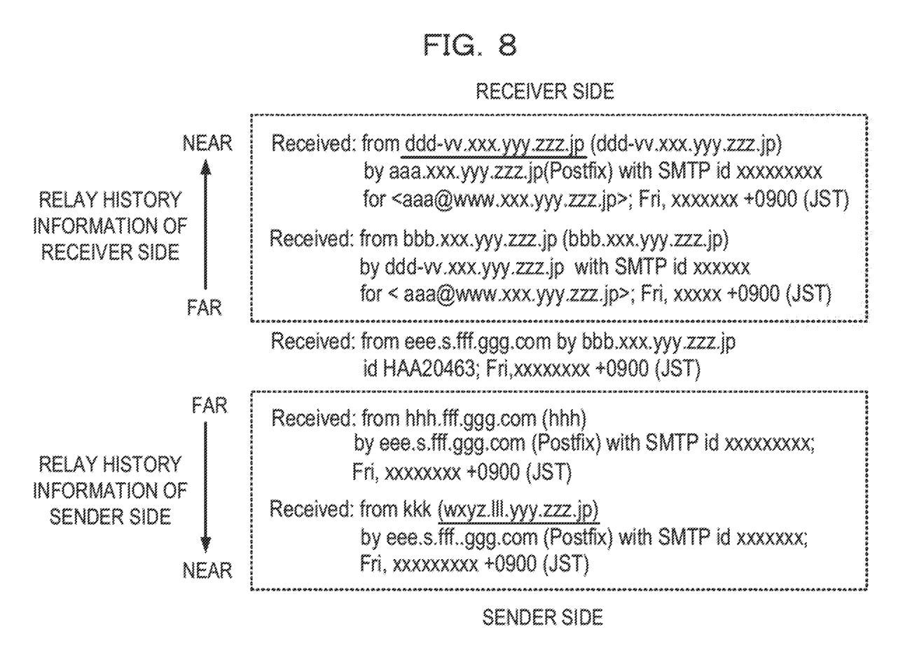

An e-mail includes header information that indicates a relay history of the e-mail in addition to the text. The disclosure request destination selection unit 124 selects disclosure candidate e-mails by referring to the header information. FIG. 8 illustrates an example of header information of an e-mail.

As illustrated in FIG. 8, the header information includes “Received” that records relay history of the e-mail. The “Received” records relay history information such as information on servers through which the e-mail passes before reaching the destination (hereunder called “server information”), and date and time.

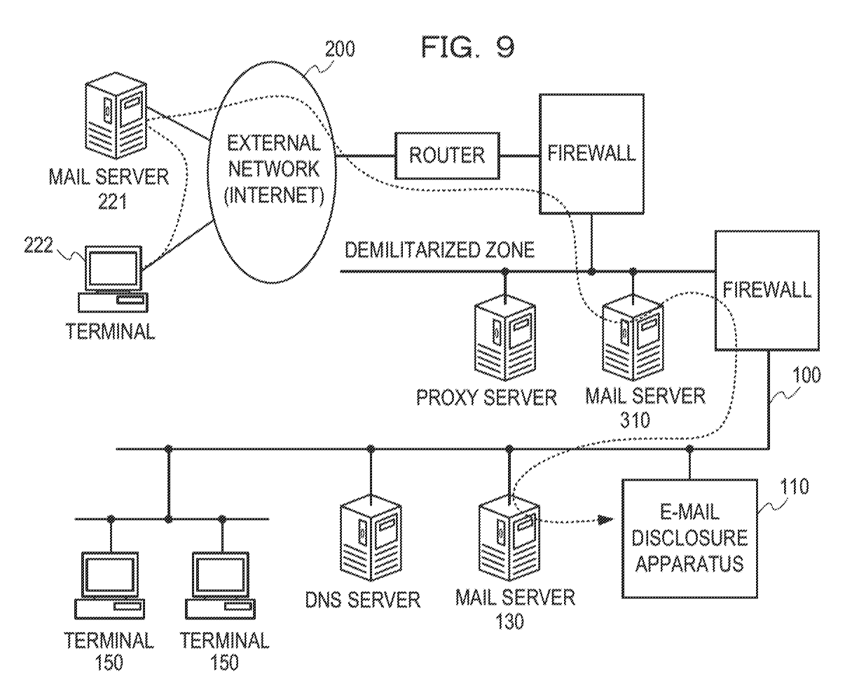

For example, in FIG. 9, the terminal 222 transmits an e-mail to a terminal 150 in an internal network 100. The dotted line in FIG. 9 illustrates the transfer route of the e-mail. The e-mail transmitted from the terminal 222 is transferred from a mail server 221 that the terminal 222 uses to a mail server 310 that is installed in a Demilitarized Zone (DMZ). The mail server 310 transfers the e-mail to the mail server 130 installed within an internal network 100. Thus, the header information of the e-mail transmitted from the terminal 222 records server information for the mail server 221 and the mail server 310.

The disclosure request destination selection unit 124 selects e-mails the disclosure attributes which are disclosure permitted from the related e-mails. The disclosure request destination selection unit 124 assumes the selected e-mails as the disclosure candidate e-mails and extracts relay history information from the header information of the disclosure candidate e-mails. From the extracted relay history information, the disclosure request destination selection unit 124 selects a given number of the candidate e-mails that are nearer to the sender of the candidate e-mails, and a given number of the candidate e-mails that are nearer to the receiver of the candidate e-mails. The relay history information that is nearer to the sender of the candidate e-mail is called “relay history information of the sender side”, while the relay history information that is nearer to the receiver of the candidate e-mail is called “relay history information of the receiver side.” The relay history information nearest to the sender corresponds to server information of a mail server that the sender uses. The relay history information nearest to the receiver corresponds to server information of a mail server that the receiver uses.

In the example illustrated in FIG. 8, the relay history information of the receiver side is displayed above the relay history information of the sender side. This is because the header information uses a format in which newer relay history information in a time series is recorded above older relay history. A header information format that records relay history in the opposite order in which newer information is recorded below older information may also be used. In this case, the upper side is relay history information of the sender side, while the lower side is relay history information of the sender side.

The inquiry and response unit 125 is notified about information on e-mails with attributes that permit disclosure among related e-mails and transmits the e-mails to the inquirer's terminal 301 as disclosure e-mails.

The disclosure request destination selection unit 124 also extracts relay history information from the header information of the inquiry e-mail from the inquirer (hereunder called “relay history information of the inquiry e-mail”).

The disclosure request destination selection unit 124 assigns numbers to the relay history information of the sender side and that of the receiver side. When N units of relay history information (“N” is any natural number) of the sender side exists, the disclosure request destination selection unit 124 assigns numbers 1,2,3 . . . N to the information units starting from the side nearer the sender. Similarly, when M units of relay history information “M” is any natural number) of the receiver side exists, the unit 124 assigns numbers 1,2,3 . . . M to the information starting from the side nearer the receiver.

The disclosure request destination selection unit 124 compares relay history information of the sender side extracted from the header information of related e-mails with relay history information of the inquiry e-mail extracted from the header information of the inquiry e-mail. For example, a case is assumed in which relay history information of the sender side is “ddd-vv.xxx.yyy.zzz.jp” and relay history information of the inquiry e-mail is “wxyz.lll.yyy.jp.” The disclosure request destination selection unit 124 deletes information from the head of the relay information to the first period, and compares the resultant two pieces of relay history information. In the above example, the disclosure request destination selection unit 124 compares “xxx.yyy.zzz.jp” with “lll.yyy.jp.” In the comparison, a perfect match or a partial match between the two pieces of relay history information may be determined. The partial match includes two cases: one is a sequential match in which sequential sections of the relay information separated by periods match, and the other is a discontinuous match in which discontinuous sections of the relay information separated by periods match. The sequential match is, for example, the sections of (wxyz) and (lll) match when (wxyz.lll.yyy.jp) and (wxyz.lll.ZZZ.jp) are compared. The discontinuous match is, for example, the sections of (yyy) and (jp) match when (xxx.yyy.zzz.jp) and (lll.yyy.stu.jp) are compared.

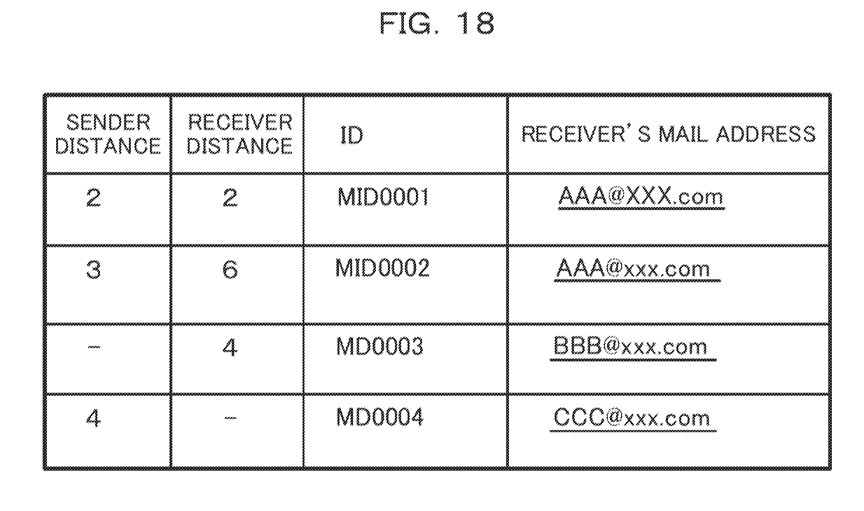

Details of the comparison procedure will be described by referring to a flow chart illustrated in FIG. 17. The disclosure request destination selection unit 124 also compares relay history information of the receiver with relay history information of the inquiry e-mail.

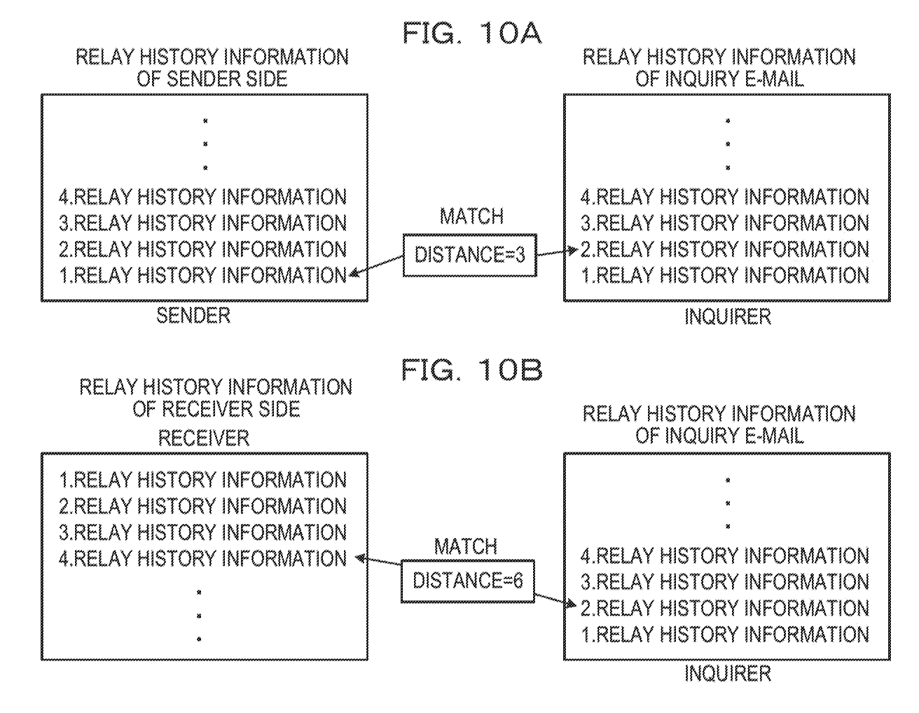

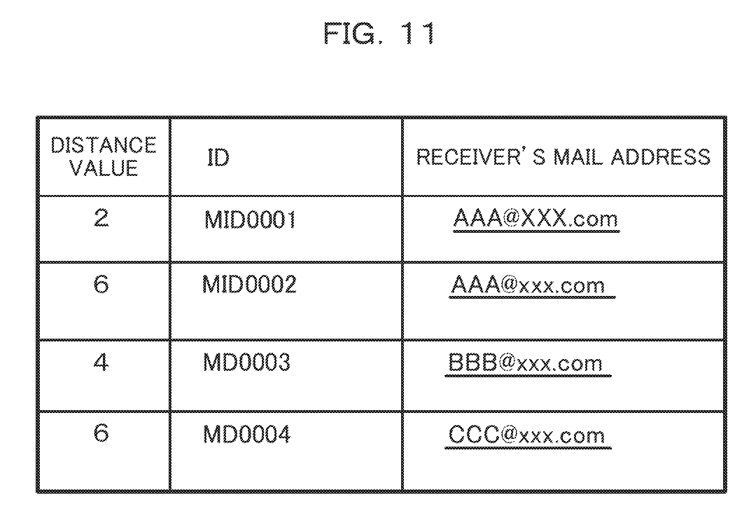

As a result of the comparison, if a perfect match or a partial match between relay history information of the sender side and that of the inquiry e-mail is found, the sum of the number of the matched relay history information of the related e-mail and the number of the matched relay history information of the inquiry e-mail is obtained. For example, in FIG. 10A, when the first relay history information of the sender side and the second relay history information of the inquiry e-mail completely matches or partially matches, the sum is 3. The obtained sum is a distance that indicates the proximity of the inquirer to the sender of the disclosure candidate e-mail within the organization. Likewise, when a partial match is found between the relay history information of the receiver side and that of the inquiry e-mail, the sum of the number of the relay history information of the receiver side and the number of the inquiry e-mail is obtained. For example, in FIG. 10B, when the fourth relay history information of the receiver and the second relay history information of the inquiry e-mail completely matches or partially matches, the obtained sum is 6. The obtained sum is a distance that indicates the proximity of the inquirer to the sender of the disclosure candidate e-mail within the organization.

Relay history information of an e-mail reflects an organizational structure. For example, in a large company, a mail server is installed for each division, thus how close divisions are, in other words, similarities between attributes of an inquirer and a sender or a receiver of a disclosure candidate e-mail, may be determined based on the relay history information.

If a large company that frequently changes the office organization manages an organizational structure by using a management table, managing the management table is complicated work. Thus, by determining the proximity of an inquirer to a sender or a receiver of a disclosure candidate e-mail based on the relay history information of an e-mail excludes the needs for setting a management table, thereby reducing the amount of work for the management.

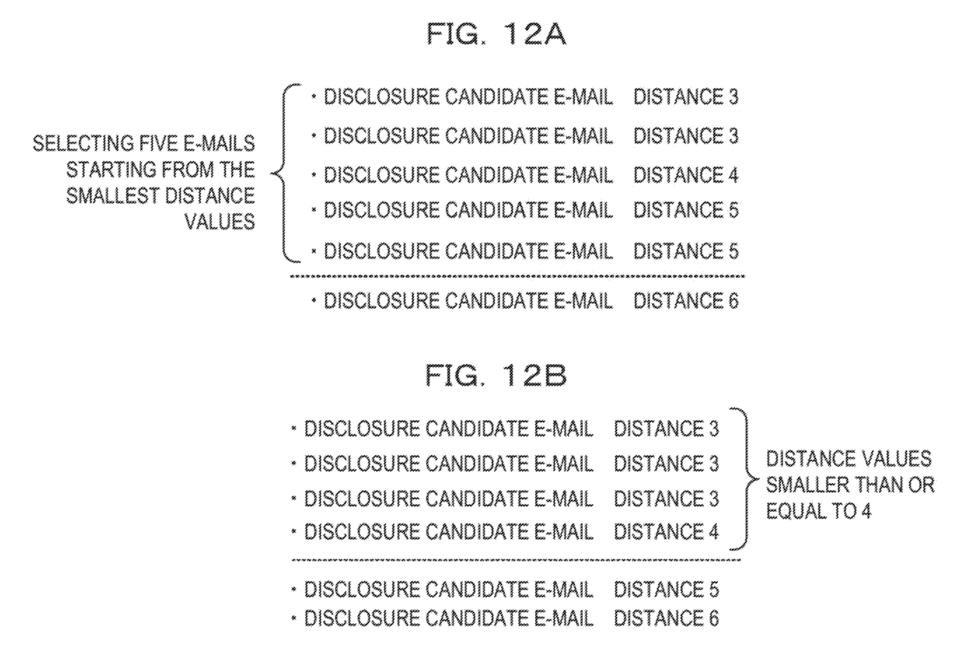

The disclosure request destination selection unit 124 stores the obtained distance value in the RAM 114. FIG. 11 illustrates a configuration of a management table of data stored in the RAM 114. As illustrated in FIG. 11, the RAM 114 stores a distance value between an inquirer and a party of a disclosure candidate e-mail in association with an identifier (ID) for identifying an e-mail, and an e-mail address of a receiver of the disclosure candidate e-mail.

When both relay history information of a sender side and that of the receiver side match with relay history information of an inquiry e-mail, the disclosure request destination selection unit 124 selects the one with a smaller value as a distance. In an example in FIG. 10A and FIG. 10B, the distance between the inquirer and the sender of the disclosure candidate e-mail is 3, and the distance between the inquirer and the receiver of the disclosure candidate e-mail is 6. Thus, the disclosure request destination selection unit 124 selects the distance 3 between the inquirer and the sender of the disclosure candidate e-mail.

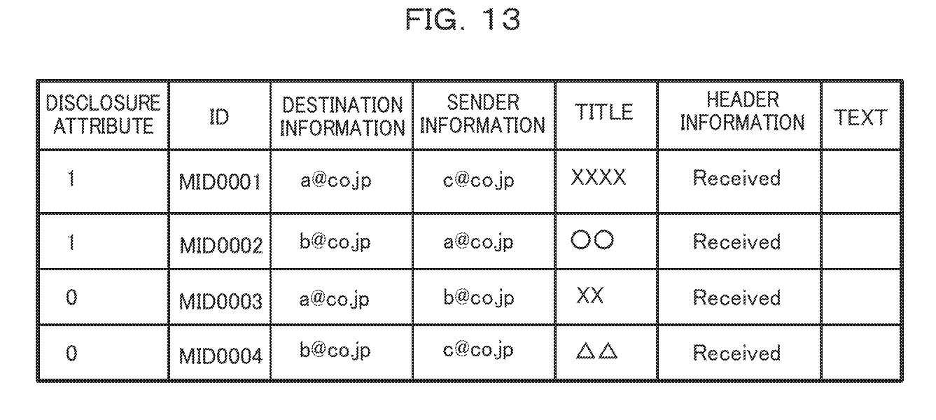

After obtaining distances between the inquirer and all of the parties of the disclosure candidate e-mails, the disclosure request destination selection unit 124 sorts the obtained distances in ascending order. The disclosure request destination selection unit 124 selects a given number of disclosure candidate e-mails starting from the e-mails with smaller values of distances, and asks the receiver of the disclosure candidate e-mails whether or not the e-mails may be disclosed or not. FIG. 12A illustrates an example in which five disclosure candidate e-mails are selected starting from the smallest distance values.

The smaller the distance value, the inquirer and the party of the disclosure candidate e-mail are closer in terms of the organization. Therefore, the possibility of a candidate e-mail being disclosed may be increased by selecting disclosure candidate e-mails with smaller distances and transmitting a request to disclose the e-mail.

The disclosure request destination selection unit 124 may be set so that the unit 124 selects disclosure candidate e-mails with a smaller distance value than a given distance and asks the receiver of the selected disclosure candidate e-mail whether or not the e-mail may be disclosed. FIG. 12B illustrates an example in which disclosure candidate e-mails with distance values are smaller than or equal to 4.

FIG. 13 illustrates a configuration of a management table of an e-mail accumulation database 116. As illustrated in FIG. 13, the e-mail accumulation database 116 records information such as a disclosure attribute, an ID, destination information, a sender information, a title, header information, and a text. The disclosure attribute is managed by flags. The flag 1 indicates the e-mail is permitted to be disclosed to all users. The flag 0 indicates that the e-mail is not permitted to be disclosed.

The destination information indicates an e-mail address to which the e-mail is addressed. In other words, the destination information indicates the e-mail address of the receiver of the disclosure candidate e-mail. The sender information indicates an e-mail address of the sender of the disclosure candidate e-mail. In addition to the above described information, the e-mail accumulation database 116 records address information of an e-mail in association with attribute information such as a division or a title.

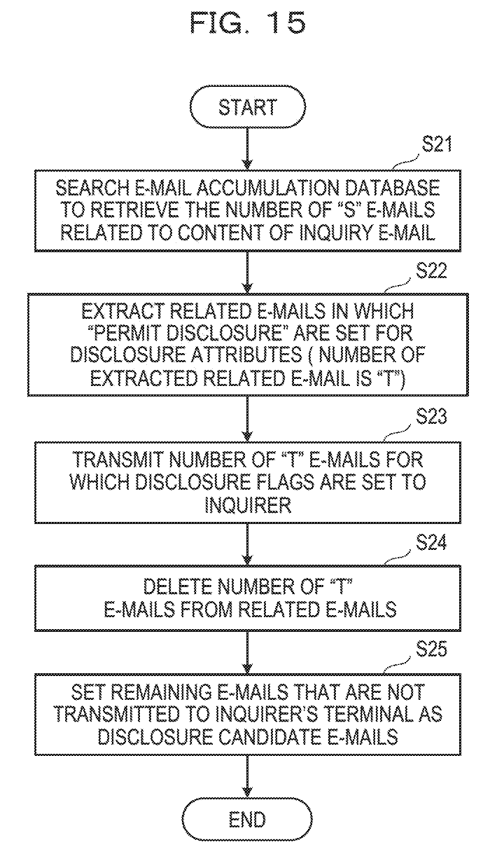

Now, a processing procedure of a control unit 111 will be described by referring to FIGS. 14 to 17.

First, an entire processing flow performed by the control unit 111 will be described by referring to the flow chart in FIG. 14.

When the control unit 111 receives an inquiry e-mail from an inquirer's terminal 301 (Operation S1: Yes), the related e-mail search unit 123 searches the e-mail accumulation database 116 (Operation S2). The related e-mail search unit 123 searches the e-mail accumulation database 116 using a search word set in the inquiry e-mail to retrieve e-mails that include the search word in the text or the title.

When related e-mails are retrieved, the control unit 111 retrieves e-mails the disclosure attribute of which is “permit disclosure” from the related e-mails and sets the e-mails as disclosure candidate e-mails (Operation S3). The related e-mails the disclosure attribute of which are “permit disclosure” are transmitted to the inquirer's terminal 301 as disclosure e-mails.

The disclosure request destination selection unit 124 of the control unit 111 calculates a distance between the inquirer and a party of a disclosure candidate e-mail (Operation S4).

The disclosure request destination selection unit 124 refers to “Received” that is recorded as header information of a disclosure candidate e-mail and extracts the relay history information of the sender side and that of the receiver side. The disclosure request destination selection unit 124 refers to “Received” recorded as header information of an inquiry e-mail and extracts the relay history information of the inquiry e-mail. The disclosure request destination selection unit 124 compares the extracted relay history information of the sender side with the relay history of the inquiry e-mail, and calculates the distance between the inquirer and the sender of the disclosure candidate e-mail. The disclosure request destination selection unit 124 also calculates a distance between the inquirer and the receiver of the disclosure candidate e-mail (Operation S4). When the disclosure request destination selection unit 124 is unable to find a perfect match or a partial match for both the relay history information of the sender side and that of the receiver side, the disclosure request destination selection unit 124 excludes e-mails under processing from the disclosure candidate e-mails.

The disclosure request destination selection unit 124, which calculates the distance between the inquirer and the sender of the disclosure candidate e-mail and the distance between the inquirer and the receiver of the disclosure candidate e-mail, selects a disclosure request destination based on the calculated distances (Operation S5). The disclosure request destination selection unit 124 notifies the inquiry and response unit 125 about the information on the selected disclosure request destination (an e-mail address). Using the inquiry and response unit 125, the control unit 111 transmits disclosure request e-mails to all of the notified disclosure request destinations (Operation S6).

When the control unit 111 receives a response e-mail from the disclosure request destination to which the disclosure request e-mail is transmitted (Operation S7: Yes), the inquiry and response unit 125 of the control unit 111 determines settings of the response e-mail (Operation S9). If the response from the disclosure request destination is to permit disclosure to all users (Operation S9: Yes), the database rewrite unit 126 of the control unit 111 changes the attributes of the disclosure candidate e-mails that are set to permit disclosure to all users (Operation S10). The e-mail accumulation database 116 records attribute information of e-mails and the database rewrite unit 126 sets a flag to “1” that indicates an attribute that permits disclosure of the e-mail.

If the control unit 111 receives a response e-mail in which “permit disclosure” is set (Operation S11: Yes), the control unit 111 transmits a response e-mail to the inquirer's terminal 301 (Operation S12). The “permit disclosure” set in the response e-mail includes “permit disclosure to all users” and “permit disclosure only to the inquirer”. The response e-mail displays such information as the sender and the receiver of the e-mail that the disclosure is permitted, and the divisions to which the sender and the receiver belong, date and time when the disclosure e-mail is received, a distance between the inquirer and the sender or the receiver of the disclosure e-mail, the relevant keyword, and the like.

When the inquirer who receives the response e-mail requests acquisition of the disclosure e-mail (Operation S13: Yes), the control unit 111 transmits the requested disclosure e-mail to the inquirer's terminal 301 (Operation S14). After that, the control unit 111 returns to Operation S8 and determines whether or not a given time has elapsed since the disclosure request e-mail was transmitted. If the disclosure request e-mail in which “permit disclosure” is set is not received at Operation S1 (Operation S11: No), the control unit 111 returns to Operation S8, and determines whether or not a given time has elapsed since the disclosure request e-mail was transmitted.

After a given time has elapsed after a disclosure request e-mail was transmitted to the disclosure request destination (Operation S8), the control unit 111 ends the processing.

According to this embodiment, the attribute of a party and a sender of inquiry e-mail, in other words, a distance in terms of an organization, is compared and based on the comparison, a disclosure candidate e-mail to which a disclosure request e-mail is transmitted is selected. Thus the present embodiment allows a user to retrieve information that has a high possibility of being viewed, and information that is meaningful and includes content relevant to the search criteria. The embodiment also allows a user to request the disclosure of the retrieved information.

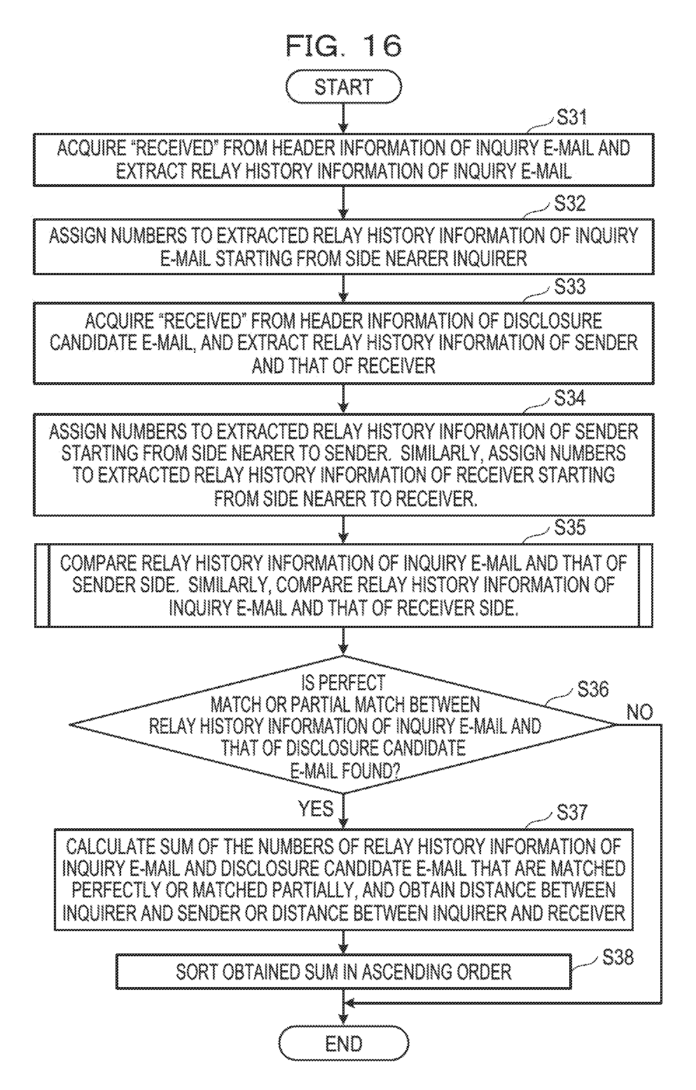

Now detailed procedures of the above Operation 3 will be described by referring to the flow chart in FIG. 15.

When the control unit 111 receives an inquiry e-mail, the unit 111 searches the e-mail accumulation database 116 to retrieve related e-mails that include a search word set by the inquiry e-mail (Operation S21). Assume that the number of related e-mails acquired by the search procedure is S (“S” is any integer). The control unit 111 refers to the disclosure attributes of the acquired related e-mails and extracts related e-mails in which “permit disclosure” is set (Operation S22). Assume that the number of the related e-mails in which “permit disclosure” is set is T (“T” is any integer which satisfies T≦S). The control unit 111 assumes the number of T related e-mails in which “permit disclosure” is set as disclosure e-mails and transmits a response e-mail that includes information on the disclosure e-mails to the inquirer's terminal 301 (Operation S23). The control unit 111 deletes the number of T transmitted disclosure e-mails from the related e-mails (Operation S24) and sets the remaining e-mails that are not transmitted to the inquirer's terminal 301 as disclosure candidate e-mails (Operation S25).

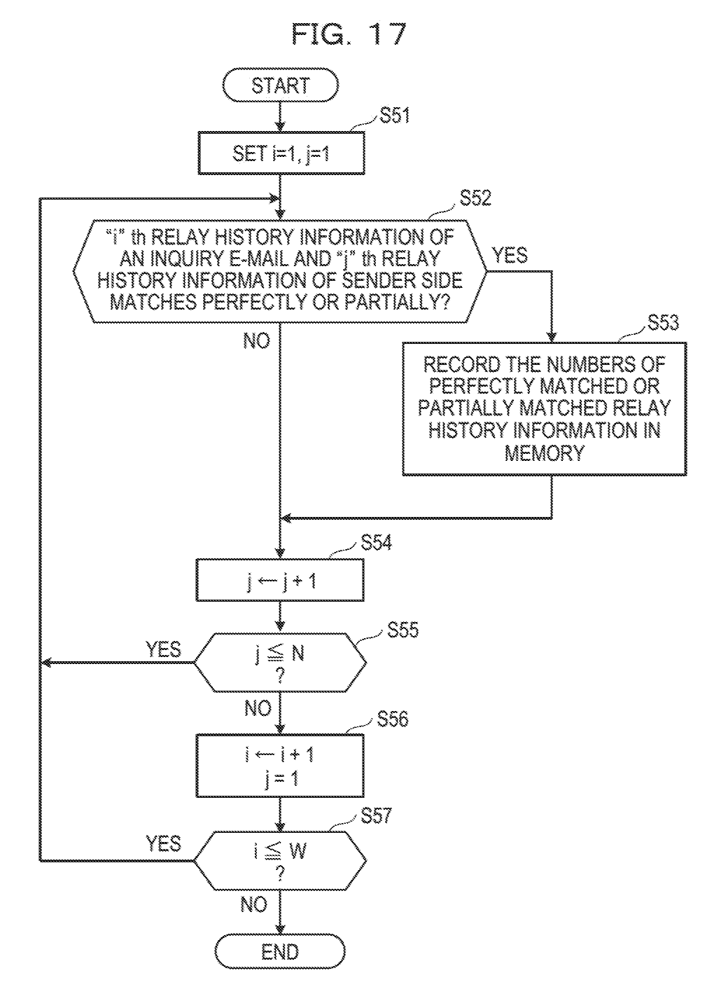

Now, a procedure to determine a distance between an inquirer and a party of a disclosure candidate e-mail will be described by referring to a flow chart in FIG. 16.

First, the control unit 111 acquires “Received” from the header information of an inquiry e-mail and extracts the relay history information of the inquiry e-mail (Operation S31).

The control unit 111 assigns numbers to the extracted relay history information of the inquiry e-mail starting from the side nearer the inquirer (Operation S32). The relay history information nearest to the inquirer is a mail server that the inquirer uses. The relay history information furthest from the inquirer is information on the e-mail disclosure apparatus 110.

The control unit 111 acquires “Received” from the header information of a disclosure candidate e-mail, and extracts the relay history information of the sender and that of the receiver (Operation S33).

The control unit 111 assigns numbers to the extracted relay history information of the sender starting from the side nearer to the sender. Likewise, the control unit 111 assigns numbers to the extracted relay history information of the receiver starting from the side nearer to the receiver (Operation S34). The control unit 111 compares relay history information of the inquiry e-mail and relay history information of the sender side. Likewise, the control unit 111 compares the relay history information of the inquiry e-mail and the relay history information of the receiver side (Operation S35).

If a perfect match or a partial match is found between the relay history information of the inquiry e-mail and that of the sender side (Operation S36: Yes), the control unit 111 records the numbers of the matched relay history information of the inquiry e-mail and that of the sender side in the RAM 114. Similarly, if the control unit 111 finds a perfect match or a partial match between the relay history information of an inquiry e-mail and that of the receiver side (Operation S36: Yes), the control unit 111 records the number of the matched relay history information of the inquiry e-mail and the number of the matched relay history information of the receiver side in the RAM 114.

The control unit 111 calculates the sum of the numbers of the relay history information that is matched perfectly or matched partially, and obtains the distance between the inquirer and the sender or the distance between the inquirer and the receiver (Operation S37). The sum of the numbers of the perfectly matched or partially matched relay history information of the inquiry e-mail and the relay history information of the sender is assumed to correspond to the distance between the inquirer and the sender. Similarly, the sum of the numbers of the perfectly matched or a partially matched relay history information of the inquiry e-mail and the relay history information of the receiver is assumed to correspond to the distance between the inquirer and the receiver.

For the same disclosure candidate e-mail, if both the relay history information of the sender side and that of the receiver side matches with the relay history information of the inquiry e-mail, the control unit 111 selects the smaller sum as a distance for the disclosure candidate e-mail.

The control unit 111 sorts the sums in ascending order (Operation S38). The e-mail disclosure apparatus 110 compares a given set value and a sum and requests a disclosure candidate e-mail receiver's terminal 302 with a sum smaller than the given set value to disclose the disclosure candidate e-mail.

Now detailed procedures of the above Operation S35 will be described by referring to a flow chart in FIG. 17. More specifically the flow that finds a match between the relay history information of an inquiry e-mail and that of a sender side will be described.

First, the control unit 111 sets a variable i to 1 and a variable j to 1 (Operation S51). The variable i identifies relay history information of an inquiry e-mail while the variable j identifies relay history information of a sender side. The control unit 111 compares and determines whether or not i=1st relay history information of an inquiry e-mail and j=1st relay history information of a sender side matches perfectly or partially (Operation S52). If the comparison reveals that the relay history information matches perfectly or partially (Operation S52/YES), the control unit 111 records the number i=1 that identifies the relay history information of the inquiry e-mail and the number j=1 that identifies the relay history information of the sender side in a RAM 114 (Operation S53). If the comparison reveals that no perfect or a partial match is found in the relay history information (Operation S52: No), the control unit 111 increments the value of i by 1 (Operation S54). The control unit 111 determines whether or not i=1st relay history information of the inquiry e-mail and j=2nd relay history information of the sender side matches perfectly or partially (Operation S52).

The control unit 111 repeats this processing until j=N (N indicates a total number of relay history information units of a sender side) is reached (Operation S55). When the processing reaches j=N, the control unit 111 increments a value of i by 1, sets j to 1 (Operation S56), and compares i=2nd relay history information of the inquiry e-mail, and j=1st relay history information of the sender side. Thereafter, the control unit 111 repeats this processing until i=W is reached, and j=N (Operation S57). The W is a variable that indicates a total number of relay history information units of the inquiry e-mail. Upon completion of the comparison between i=W^{th} relay history information of an inquiry e-mail and j=N^{th} relay history information of a sender side (Operation S57), the control unit 111 ends the processing.

A flow of finding a match between relay history information of an inquiry e-mail and that of a receiver side is performed by similar procedures, thus the details of processing will not be described here.

The present embodiment allows a search to retrieve meaningful information that includes a content satisfying a search criteria and information with a high possibility to be viewed, and requesting an authorized party of the information to disclose such information.

### Embodiment 2

Now, a second embodiment will be described by referring to the accompanying figures. A configuration of the second embodiment is almost the same as that of the first embodiment. Thus, in the second embodiment, only parts that differ from the first embodiment will be described.

In the second embodiment, the relay history information of a sender side and that of an inquiry e-mail are compared to find a perfect or a partial match between the two. Likewise, the relay history information of a receiver side and that of the inquiry e-mail are compared to find a perfect or a partial match between the two. At this time, two kinds of disclosure candidate e-mails exist. One is a candidate e-mail where both the relay history information of a sender side and that of a receiver side match with the relay history information of the inquiry e-mail; the other is a candidate e-mail where either the relay history information of the sender side or that of the receiver side matches with the relay history information of the inquiry e-mail. A disclosure candidate e-mail that matches relay history information of an inquiry e-mail with both relay history information of a sender side and that of a receiver side is called a “both-side matching e-mail.” A candidate e-mail that either a relay history information of a sender side or that of a receiver side matches with the relay history information of an inquiry e-mail is called a “one-side matching e-mail.”

According to the first embodiment, when both relay history information of a sender side and that of a receiver side match with relay history information of an inquiry e-mail, the smaller distance value is selected as a distance from the party of the disclosure candidate e-mail. According to the second embodiment, a priority of the “both-side matching e-mail” is set higher than the “one-side matching e-mail.” In other words, the nearer an inquirer's division is to the divisions of the receiver and the sender of the candidate e-mail, the higher the possibility that the e-mail is likely to be disclosed and useful.

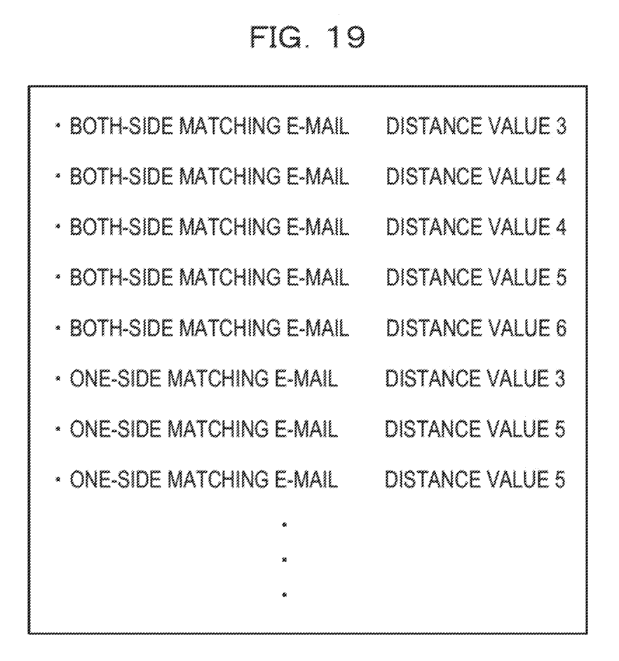

FIG. 18 illustrates a configuration of a management table recorded in a RAM 114. As illustrated in FIG. 18, the RAM 114 records a distance between a sender of a disclosure candidate e-mail and an inquirer (hereunder called a “sender distance”), and a distance between a receiver of the disclosure candidate e-mail and the inquirer (hereunder called a “receiver distance”).

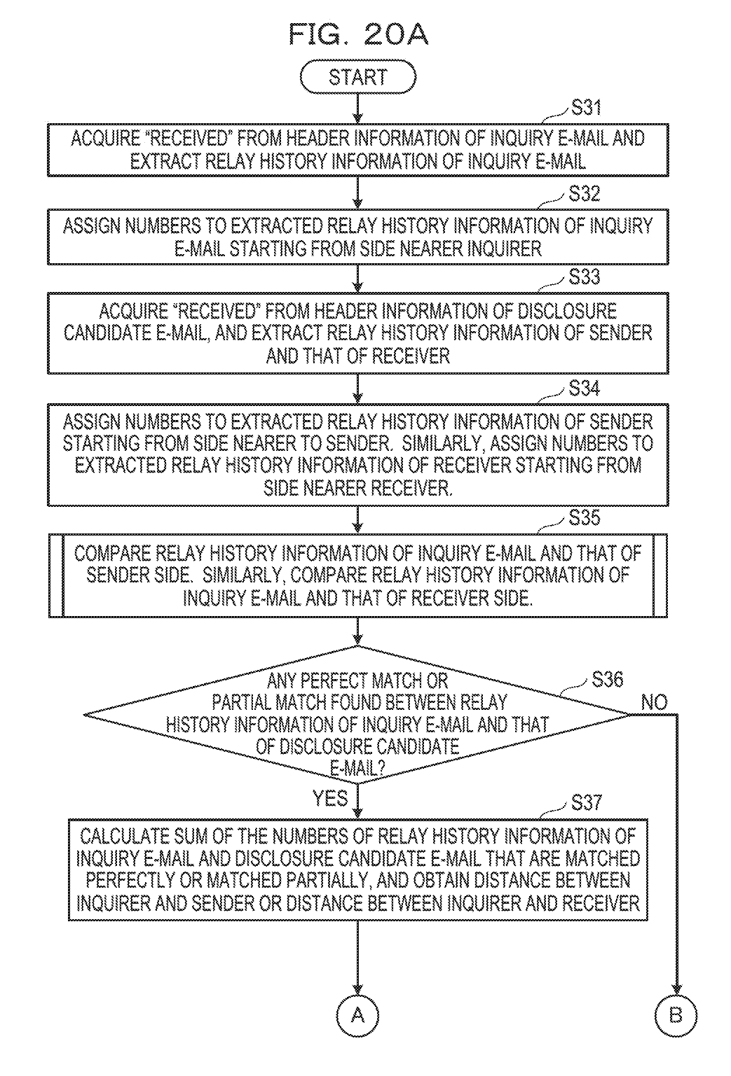

The disclosure request destination selection unit 124 refers to the management table in the RAM 114 illustrated in FIG. 18, and adds the sender distance to the receiver distance to calculate a distance value of the both-side matching e-mail. The disclosure request destination selection unit 124 also calculates a distance value of the one-side matching e-mail. As illustrated in FIG. 19, the disclosure request destination selection unit 124 sorts the e-mails so that the both-side matching e-mails are listed on top and the one-side matching e-mails are listed below in the list.

The e-mails nearer to a sender or a receiver may be emphasized by weighting a sender or a receiver of a disclosure candidate e-mail.

For example, when a sender of a disclosure candidate e-mail is emphasized, the sender distance may be doubled and added to the receiver distance. In other words, the smaller the sender distance before doubling, the smaller the distance value of the both-side matching e-mail is. Conversely, the larger a sender distance before doubling, the larger the distance value of the both-side matching e-mail is.

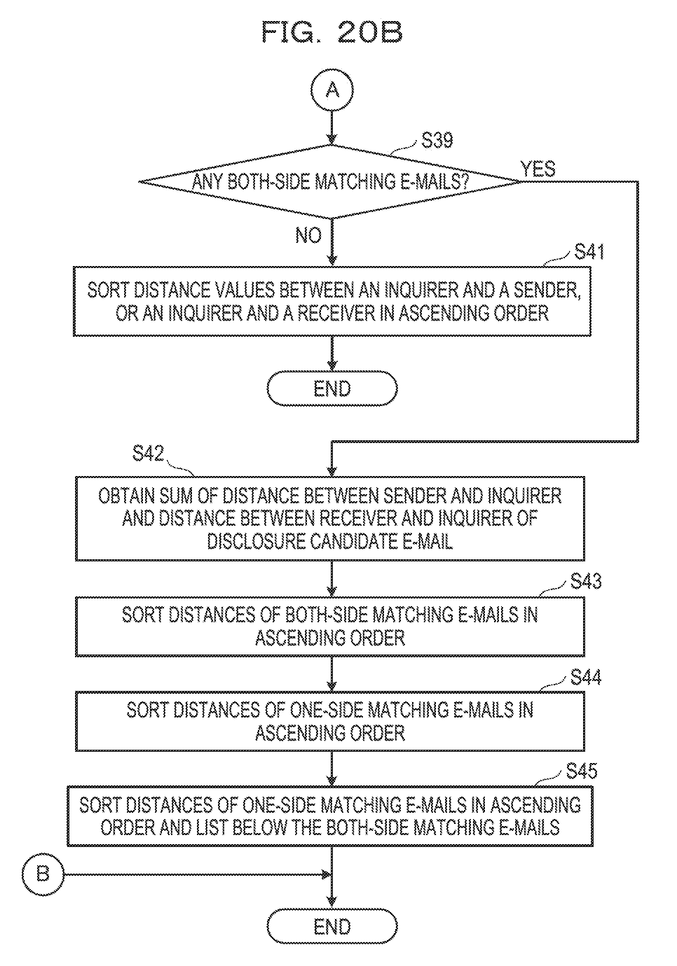

Now, the processing procedure of the control unit 111 according to the second embodiment will be described by referring to a flow chart in FIG. 20.

In the flow chart in FIG. 20, processing up to Operation S37 is described in the first embodiment. Thus, hereunder, the processing after Operation S37 will be described.

The control unit 111 obtains at least one of the distances between an inquirer and a sender of a disclosure candidate e-mail, or an inquirer and a receiver of the disclosure candidate e-mail (Operation S37). The control unit 111 determines whether or not a both-side matching e-mail exists (Operation S39). In other words, the control unit 111 determines whether or not there is any disclosure candidate e-mail that both the relay history information of the sender and that of the receiver match with the relay history information of the inquiry e-mail. If the control unit 111 determines that a both-side matching e-mail does not exist (Operation S39: No), the control unit 111 sorts distance values between an inquirer and a sender, or an inquirer and a receiver in ascending order (Operation S41).

If the control unit 111 determines that a both-side matching e-mail exists (Operation S39: Yes), the control unit 111 obtains a sum of a sender distance and a receiver distance of the both-side matching e-mail (Operation S42). The control unit 111 stores the obtained value in the RAM 114. The control unit 111 sorts distances of the both-side matching e-mails in an ascending order (Operation S43).

The control unit 111 sorts distances of the one-side matching e-mails in an ascending order (Operation S44). Then, the control unit 111 sorts the distances of the both-side matching e-mails in an ascending order. Furthermore, as illustrated in FIG. 19, the control unit 111 sorts the distances of the one-side matching e-mails in ascending order and lists the one-side matching e-mails under the both-side matching e-mails (Operation S45).

As described above, according to this embodiment, a priority may be set to a disclosure candidate e-mail with a distance between the sender and the receiver of the candidate mail and the inquirer that is nearer in terms of the organization. Thus, a disclosure candidate e-mail with a higher possibility to be disclosed may be selected.

### A Third Embodiment

Now, a third embodiment will be described by referring to the accompanying figures.

According to the above described first embodiment and second embodiment, the disclosure request destination selection unit 124 calculates a distance between an inquirer and a sender of a disclosure candidate e-mail or a distance between the inquirer and a receiver of the disclosure candidate e-mail, and constricts the disclosure candidate e-mails to which disclosure request e-mails are transmitted based on the distances.

However, if a constriction condition for distance values is not strict, and calculated distances are not substantially different, disclosure request e-mails may be transmitted to almost all of the receivers of the disclosure candidate e-mails. Conversely, if a constriction condition for distance values is strict, very few disclosure request e-mails may be transmitted. If a large number of e-mails for a specific user are accumulated in the mail accumulation database 116, transmission of disclosure request e-mails may be concentrated on the specific user.

Thus, according to this embodiment, a condition for constricting disclosure candidate e-mails (hereunder, called a “constriction condition”) and the results of constriction are notified to an inquirer before sending disclosure request e-mails. The inquirer may change the constriction condition. The constriction condition includes a distance value, the number of disclosure candidate e-mails to which disclosure request e-mails are transmitted, the maximum number of disclosure request e-mails that may be transmitted for one destination, and the like.

The inquirer receives the constriction condition and the number of the constricted disclosure candidate e-mails from the e-mail disclosure apparatus 110, and changes the constriction condition. For example, if the number of disclosure candidate e-mails notified by the e-mail disclosure apparatus 110 is small, a distance condition may be alleviated, for example disclosure candidate e-mails with a distance value of 3 may be changed into 5. Conversely, if the number of disclosure candidate e-mails notified by the e-mail disclosure apparatus 110 is too many, the maximum number of disclosure candidate e-mails may be decreased, or the number of disclosure request e-mails directed to one destination may be limited.

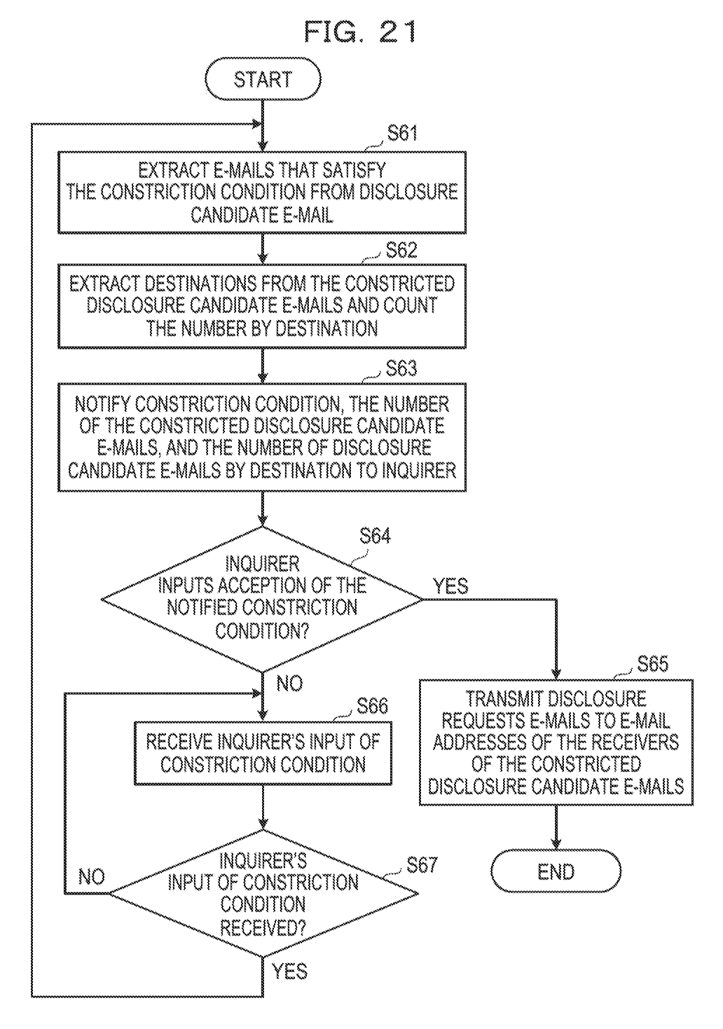

The processing procedure of the e-mail disclosure apparatus 110 according to this embodiment will be described by referring to a flowchart in FIG. 21.

The control unit 111 extracts e-mails that satisfy the constriction condition from the disclosure candidate e-mails (Operation S61). As described in the first embodiment and the second embodiment, the distance between the party of a disclosure candidate e-mail and an inquirer of an inquiry e-mail is obtained, and based on the distance, disclosure candidate e-mails to which disclosure request e-mails are transmitted are constricted.

The control unit 111 extracts destinations (an e-mail address of the receiver) from the constricted disclosure candidate e-mails and counts the number for each destination (Operation S62). The control unit 111 sends notification of a constriction condition, the number of the constricted disclosure candidate e-mails, and the number of disclosure candidate e-mails for each destination to the inquirer (Operation S63). The control unit 111 that sends the notification to an inquirer's terminal 301 waits for a response from the inquirer. If the inquirer inputs that the inquirer accepts the notified constricting condition (Operation S64: Yes), the control unit 111 transmits the disclosure requests e-mails to e-mail addresses of the receivers of the constricted disclosure candidate e-mails (Operation S65). If the inquirer does not input that the inquirer accepts the notified constricted condition (Operation S64: NO), the control unit 111 waits for the inquirer's input of constriction condition. If the control unit 111 receives the inquirer's input of constriction condition (Operation S67: Yes), the control unit 111 further constricts disclosure candidate e-mails by applying the received constriction condition (Operation S61). As described above, the control unit 111 counts the number of disclosure candidate e-mails for each destination (Operations S62), and notifies the constriction condition, the number of constricted disclosure candidate e-mails, and the number of disclosure candidate e-mails for each destination, and the like to the inquirer.

As described above, this embodiment allows an inquirer to freely set a condition for constricting disclosure candidate e-mails. Thus, an inquirer may set the number of e-mails to be disclosed. Moreover, counting the numbers of disclosure candidate e-mails for each destination prevents a large amount of disclosure candidate e-mails from being transmitted to one destination.

Although a few preferred embodiments of the present invention have been shown and described, it would be appreciated by those skilled in the art that changes may be made in these embodiments without departing from the principles and spirit of the invention, the scope of which is defined in the claims and their equivalents.

For example, in the above described embodiments, the e-mail disclosure apparatus 110 is installed within an internal network 100. However, for example, when sharing e-mails among users of the Internet is preferable, the e-mail disclosure apparatus 110 may be installed in an external network 200 illustrated in FIG. 1. In the above described embodiment, the mail server 130 is installed in the internal network 100 where the e-mail disclosure apparatus 110 is installed. However, if the e-mail disclosure apparatus 110 can acquire e-mails beyond a firewall, the mail server may be installed at the position of a mail server 221 or a mail server 310 illustrated in FIG. 9.

In the above described embodiments, disclosure of a disclosure candidate e-mail is requested to a receiver of the candidate e-mail, however, such a request may be directed to the sender of the candidate e-mail instead.

The information search method explained in this embodiment may be achieved by causing a computer such as a personal computer and/or a workstation to execute a prepared program. Such a program may be stored in a computer-readable storage medium such as a hard disk, a flexible disk, compact disc ROM (CD-ROM), magneto-optical (MO) disk, and digital versatile disk (DVD), and executed by a computer. The program may be transmission medium distributable through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information search method in which a computer executes an information search process, wherein the computer performs:
receiving a search request from a searcher's terminal;
searching for and retrieving, from a database, candidate information that includes a content satisfying a search criteria set in the search request;
constricting the retrieved candidate information based on similarities between an attribute of an authorized person who is authorized to determine disclosure and non-disclosure of the candidate information included in the candidate information, and an attribute of a searcher who transmits the search request from the searcher's terminal;
transmitting disclosure requests for the constricted candidate information to the authorized person's terminal; and
receiving a response to the disclosure request and transmitting, to the searcher's terminal, candidate information which received a response permitting disclosure.

2. The information search method according to claim 1, wherein the search request is information transmitted from the searcher's terminal as an e-mail, and the candidate information is information transmitted from a sender to a receiver as an e-mail, and
the constricting is performed by finding a match between relay history information of the search request indicating an attribute of the searcher and relay history information of the retrieved candidate information indicating an attribute of the authorized person.

3. The information search method according to claim 2, wherein the relay history information is information that records identification information units of relay apparatuses that relay the search request and identification information units of relay apparatuses that relay the candidate information in order of the relay sequence; and
the constricting assumes a sum of the number of relay history information units from the identification information of a relay apparatus that first relays the search request up to the matched relay history information of the search request, and the number of relay history information units from the identification information of a relay apparatus that first relays the candidate information up to the matched relay history information of the candidate information is a value indicating an organizational distance between the searcher and a sender of the candidate information, and determines that the candidate information with the smaller distance value is candidate information with a high similarity.

4. The information search method according to claim 2, wherein the relay history information is information that records identification information of relay apparatuses that relay the search request and identification information of relay apparatuses that relay the candidate information in order of the relay sequence; and
the constricting assumes a sum of the number of relay history information units from the identification information of a relay apparatus that first relays the search request up to the matched relay history information of the search request, and the number of relay history information units from identification information of a mail server that receives the candidate information up to the matched relay history information of the candidate information is a value indicating an organizational distance between the searcher and a receiver of the candidate information, and determines that the candidate information with the smaller distance value is the candidate information with a high similarity.

5. The information search method according to claim 2, wherein the relay history information is information that records identification information of relay apparatuses that relay the search request and identification information of relay apparatuses that relay the candidate information in order of the relay sequence; and
the constricting further comprising:
finding a match between relay history information of a sender side within a given number counting from the identification information of a relay apparatus that first relays the candidate information and relay history information of the search request;
finding a match between relay history information of a receiver side within a given number of relay history information units from the identification information of a mail server that receives the candidate information and relay history information of the search request; and
determining candidate information with a search request relay history that matches both the relay history information of the sender side and the relay history information of the receiver side as candidate information with a high similarity.

6. An information search apparatus comprising:
a receiving unit which receives a search request from a searcher's terminal;
a search unit which searches and retrieves, from a database, candidate information that includes a content satisfying a search criteria set in the search request;
a constriction unit which constricts the retrieved candidate information based on similarities between an attribute of an authorized person who is authorized to determine disclosure or non-disclosure of the candidate information included in the candidate information, and an attribute of the searcher who transmits the search request from the searcher's terminal; and
a transmission unit which transmits disclosure requests for the constricted candidate information to an authorized person's terminal and transmits candidate information in which a response for the disclosure request received by the receiving unit is set to permit disclosure to the searcher's terminal.

7. A computer-readable storage medium storing an information search program causing a computer to execute:
receiving a search request from a searcher's terminal;
searching for and retrieving, from a database, candidate information that includes a content satisfying a search criteria set in the search request;
constricting the retrieved candidate information based on similarities between an attribute of an authorized person who is authorized to determine disclosure or non-disclosure of the candidate information included in the candidate information, and an attribute of the searcher who transmits the search request from the searcher's terminal;
transmitting disclosure requests for the constricted candidate information to an authorized person's terminal; and
receiving a response for the disclosure request and transmitting, to the searcher's terminal, candidate information for which a response to permit disclosure is received.
